(19) United States
(12) Patent Application Publication
(10) Pub. No.: US 2007/0199348 A1
(43) Pub. Date: Aug. 30, 2007

(54) Method of preparing textured glass ceramics

(76) Inventors: Katherine Ann Gudgel, Evanston, IL (US); Peter Blaum, Bodenheim (DE); Mark J. Davis, Clarks Summit, PA (US); Paula Vullo, Pittston, PA (US)

Correspondence Address: HARNESS, DICKEY & PIERCE, P.L.C., P.O. BOX 828, BLOOMFIELD HILLS, MI, 48303, US

(21) Appl. No.: 11/698,936

(22) Filed: Jan. 26, 2007

Related U.S. Application Data
(60) Provisional application No. 60/764,037, filed on Feb. 1, 2006.

(51) Int. Cl. C03C 10/00; C03B 27/012; C03B 32/00

(52) U.S. Cl. 65/33.1

(57) ABSTRACT

A method of preparing a textured glass ceramic is disclosed which comprises the steps of preparing a precursor glass, preparing a precursor glass body, placing the precursor glass body in a furnace in contact with a brick body having a larger or smaller thermal capacity than formed by the precursor glass body, and ceraming the precursor glass body within the furnace in contact with the brick body thereby effecting a temperature gradient across the precursor glass body for precipitating crystallites having a preferred direction of orientation.

### RELATED APPLICATIONS

This application is based on U.S. provisional application Ser. No. 60/764,037 filed on Feb. 1, 2006 the contents of which are fully incorporated herein by reference.

### BACKGROUND OF THE INVENTION

The invention relates to a method of preparing textured glass ceramics, more particularly to a method of preparing glass ceramics comprising crystallites having a preferred orientation. The invention further relates to a method of preparing non-ferroelectric polar glass ceramics showing piezoactivity.

Glass ceramics have experienced widespread use over the last decades. Currently, glass ceramics have become more and more important as a class of modern materials, due to their potential for tailored characteristics and for large scale production.

Lately glass ceramics have even been investigated as potential substitute materials for conventional piezoelectric materials. Piezoelectric glass ceramic materials provide an interesting and promising alternative to conventional piezoelectric materials such as PZT ceramics. Since PZT apart from zirconium and titanium contains lead, piezoelectric glass ceramics have a potential to replace PZT as an alternative lead-free material. One possibility for obtaining piezoelectric behavior in a glass ceramic, requires that the glass ceramic must comprise ferroelectric crystallites that can be poled to reach a macroscopic piezoelectric behavior. Alternatively, if the glass ceramic comprises non ferroelectric polar crystallites, a preferred orientation of the crystallites must be “imprinted” on the material during manufacture. Thus the glass ceramic must comprise non symmetric crystallites that are textured during manufacture.

Textured glass ceramics are also of interest with respect to other characteristics, e.g. improved mechanical strength in a particular direction.

Thus a method of preparing a textured glass ceramic is of particular importance in the manufacture of various glass ceramics.

C. Rüssel, “Oriented crystallization of glass—a review”, Journal of Non-Crystalline Solids 219 (1997), 212-218, gives a summary of the methods known in the prior art to prepare textured glass ceramics. In principle, three different preparation routes are known. The first one is mechanic deformation of a glass which might be partially crystalline. The second one is a kinetically controlled crystallization in which the crystallization occurs solely in a small region, in particular at the surface, and the rates of crystal growth are different for different crystallographic directions. The third method is thermodynamically controlled crystallization in which applied conditions decrease the free enthalpy of nuclei or crystallites formed, if they are oriented, e.g. parallel to an externally applied magnetic field.

Only the second method reported by Rüssel has been used in the prior art as a practical method for preparing textured glass ceramics. The glass is placed in a temperature gradient within a furnace usually generated by local heating elements. Usually, the thickness of the textured surface layer grown by surface crystallization in the temperature gradient does not exceed 500 micrometers. However, larger oriented structures can be grown when the specimen is slowly moved within the temperature gradient.

Moving the glass sample within a temperature gradient was also reported by Y. Abe et al., “Preparation of High-Strength Calcium Phosphate Glass-Ceramics by Unidirectional Crystallization”, Communications of the American Ceramic Society”, July 1984, by G. Lu et al., “Unidirectional Crystallization of Potassium Disilicate”, Journal of Crystal Growth 64, 1983, 479-484, by F. Carpay et al., “In-situ Growth of Composites from the Vitreous State”, Journal of Crystal Growth 24/25, 1974, 551-554, as well as by K. Engel et al., “Textured Li2O.2SiO2 glass ceramics”, Journal of Non-Crystalline Solids 196, 1996, 339-345.

Halliyal et al., “Glass ceramics for piezoelectric and pyroelectric devices”, in Glass and Glass-ceramics, edited by M. H. Lewis, pp. 273-315, Chapman and Hall, London, 1989, investigated a variety of glass ceramics showing piezoelectric or pyroelectric behavior. In particular, they investigated a glass-ceramic material prepared from lithium borosilicate precursor glasses (Li₂O—B₂O₃—SiO₂). Halliyal et al. used a crystallization in a temperature gradient which was generated by positioning polished glass samples on a microscope hot stage. Thereby piezoelectric samples could be prepared from non-ferroelectric piezo-active materials by effecting a preferred direction of orientation of the precipitated crystallites.

However, moving a glass sample or rod within a temperature gradient as well as the hot stage method impose considerable restrictions on the production and are not well suited for producing textured glass ceramics on a larger scale.

### SUMMARY OF THE INVENTION

In view of this it is a first object of the invention to disclose a method of preparing a textured glass ceramic from a precursor glass, whereby a controlled texture can be reached.

It is a second object of the invention to disclose a method of preparing a textured glass ceramic from a precursor glass allowing to manufacture glass ceramics having marked anisotropy effected by a preferred orientation of crystallites precipitating during the ceraming step.

It is a third object of the invention to disclose a method of preparing a textured glass ceramic from a precursor glass allowing to control of the anisotropy reached during ceraming.

It is a forth object of the invention to disclose a method of preparing a textured glass ceramic from a precursor glass that is cost effective and has a potential for a large scale production.

These and other objects of the invention are achieved by a method of preparing a textured glass ceramic, comprising the steps of:
preparing a precursor glass body;
placing the precursor glass body in a furnace in contact with a brick body having a larger or smaller thermal capacity than formed by the precursor glass body; and
ceraming the precursor glass body within the furnace in contact with the brick body.

According to the invention a temperature gradient is employed across the precursor glass during the precipitation of crystallites. This is done within a furnace by placing the precursor glass in contact with a brick body having a larger (or smaller) thermal capacity than formed by the precursor glass body. By controlling the thermal capacity (sometimes also called “heat capacity”) of the brick body, the temperature gradient can be specifically controlled. Thermal capacity is defined as the specific heat capacity multiplied by the mass.

Also complex temperature gradients and thereby textured structures can be generated by a respective brick material body which e.g. may contact the precursor glass body also on one or more face sides apart from the contact at the bottom.

Using this “brick method” a controlled temperature gradient can be obtained during the ceraming process in a very simple way whereby a carefully controlled texture or more pronounced anisotropy of the glass ceramic generated thereby can be effected. In particular, the orientation, distribution and size of the crystals can be controlled or at least influenced thereby.

The temperature gradient that results, when heating the precursor glass body in contact with the brick body, depends largely on the ratio between the thermal capacities given by the brick body and the precursor glass body.

Preferably, the ratio between the thermal capacities of the brick body and the precursor glass body is at least 10, preferably at least 100, more preferably at least 1000, mostly preferred at least 10000.

Using such large ratios very pronounced textures of the glass ceramic can be reached.

According to a refinement of the invention, in addition, the brick body that is placed in the furnace in contact with the precursor glass body may be cooled or heated during the ceraming step, this allowing to effect even more pronounced temperature gradients and thus an even more aligned orientation of the precipitated crystallites.

According to another embodiment of the invention the texture of the glass ceramic may be influenced by the material from which the brick body is made. In addition, also the thermal conductivity of the brick material may influence the temperature gradient and thus also the texture resulting therefrom.

According to another embodiment of the invention a brick body may be used which is made of a thermally insulating material such as a material selected from the group formed by silica, alumina and zirconia. Alternatively, also a material may be used, that is a good thermal conductor, such as steel or graphite.

According to another embodiment of the invention the surface of the precursor glass body in contact in the brick material body, preferably also the opposite surface, is polished prior to contacting the brick material body.

It was found that a more pronounced anisotropy can be effected when using this polishing step. The polishing leads to the formation of micro-cracks which act as nuclei enhancing surface crystallization.

Preferably, also the surface(s) of the brick material body that get in contact with the precursor glass body are ground or polished.

Also this facilitates a high degree of alignment of the crystallites with the glass ceramic.

According to another embodiment of the invention the brick body is provided with a recess, wherein the precursor glass body is placed.

Herein the recess may be dimensioned to allow a complete seating of the precursor glass body therein, in a flush configuration or in a configuration recessed within the brick body.

Thus the surface crystallization starts only from one surface whereby an improved texture can be reached.

The surface crystallization starting from a surface may be further enhanced by seeding at least one surface of the precursor glass body by thermal or chemical treatment.

While the depth of the crystallization which can be reached using surface crystallization as the main crystallization mechanism is somewhat limited, according to the invention a crystallization depth in the range of one millimeter or even more can be reached.

The crystallization depth in some cases may be even more increased by using a precursor glass that is prepared with nucleating agents within the bulk.

For this purpose the precursor glass body may be prepared with a particular nucleation step to reach a certain homogeneous nucleation within the precursor glass before ceraming the precursor glass within a temperature gradient.

According to another development of the invention, the method may further comprise the step of establishing a gas flow within the furnace, the gas flow being directed to influence the temperature gradient established within the precursor glass body.

According to another development of the invention, the method may further comprise the step of treating the surface(s) of the brick body that get into contact with the precursor glass body to effect easy removal of the ceramized body after ceramization, in particular by treating the surface(s) with soapstone.

A particular advantageous application of the invention is the preparation of non-ferroelectric glass ceramics being piezoelectric.

To this end a precursor glass may be used which comprises Li₂O, B₂O₃ and SiO₂.

Using lithium borosilicate glasses as a precursor glass stable glass ceramics showing piezoelectric behavior can be prepared.

More particularly, the precursor glass may comprise 55 to 80 wt.-% of SiO₂, 1 to 40 wt.-% of B₂O₃ and 1 to 30 wt.-% of Li₂O, preferably 65 to 75 wt-% of SiO₂, 5 to 15 wt-% of B₂O₃ and 15 to 25 wt.-% of Li₂O.

In particular, a precursor glass can be used which comprises 70 to 73 wt.-% of SiO₂, 9 to 11 wt.-% of B₂O₃, and 18 to 22 wt.-% of Li₂O.

Using such precursor glasses allows to prepare stable glass ceramics that show relatively low dielectric constants allowing for high g₃₃ values and for moderate d₃₃ values.

### BRIEF DESCRIPTION OF THE DRAWINGS

In the following the invention is more fully described with reference to the drawings and to some non-limiting examples which are merely of exemplary nature. In the drawings show:

FIG. 1 a schematic representation of the method according to invention for generating a preferred direction of orientation of precipitated crystallites in comparison to a conventional ceramization; and

FIG. 2 a plot of the texture ranking (given in arbitrary units with 4 being highly textured) over thermal capacity of different brick samples.

### DETAILED DESCRIPTION OF THE PREFERRED EMBODIMENTS

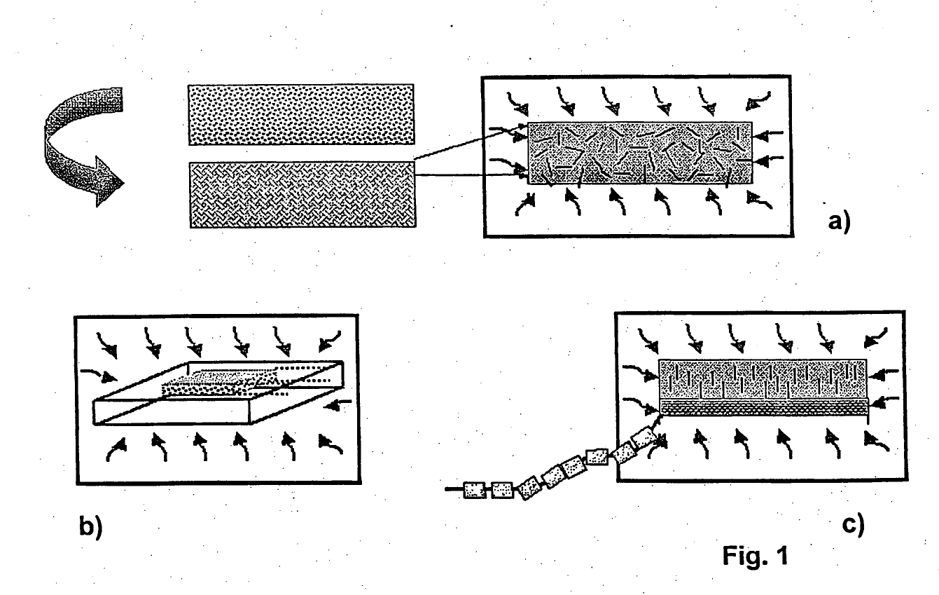

The brick method used according to the invention is generally indicated in FIG. 1. FIG. 1a) shows the conventional method of producing a glass ceramic from a precursor glass within a furnace. A controlled crystallization uses a specific heating cycle to effect nucleation and growth so that crystallites will grow randomly dispersed as shown schematically in FIG. 1a). Thus, in this way a texture cannot be generated.

To reach a texture of the glass ceramic, a temperature gradient is applied during the ceramization of the glass ceramic. This is effected according to the invention by placing the precursor glass body on a brick body that has a larger (or smaller) thermal capacity than has the precursor glass body. This procedure is schematically shown in FIG. 1b).

According to a further variant of the invention, in addition, the substrate or brick body may be cooled (or heated) to effect an even more pronounced arrangement of the crystallites in a preferred direction (which is perpendicular to the surface of the brick and within the direction of the temperature gradient). This is shown in FIG. 1c).

### EXAMPLES

In Table 1 the composition of a precursor glass that was used to prepare glass ceramics according to the invention (examples 1 to 4) is shown.

TABLE 1
Composition of examples

Example
1, 2, 3, 4
Composition
LB0-15

| Component | mol-% | wt.-% |
|---|---|---|
| SiO₂ | 60.0 | 71.1 |
| B₂O₃ | 6.7 | 9.2 |
| Li₂O | 33.3 | 19.7 |
| Total | 100.0 | 100.0 |

TABLE 2
Ceramization results: all samples textured and all samples piezoelectric

| | Example | | | |
|---|---|---|---|---|
| | 1 | 2 | 3 | 4 |
| Nucleation | none | none | none | none |
| temperature Tnuc | | | | |
| (° C.) | | | | |
| Nucleation time | none | none | none | none |
| tnuc (hrs) | | | | |
| Max. Crystallization | 825 | 825 | 825 | 825 |
| temperature | | | | |
| Tgr (° C.) | | | | |
| Crystallization | 4 | 4 | 4 | 4 |
| time tgr (hrs) | | | | |
| Heating rate q- | 300 | 300 | 300 | 300 |
| heat (K/hr) | | | | |
| Cooling rate q- | 300 | 300 | 300 | 300 |
| cool (K/hr) | | | | |
| Surface Finish | Polished Faces | Polished Faces | Polished Faces | Polished Faces |
| Texture Ranking | 2 | 1 | 4 | 3 |
| (4 is highly | | | | |
| textured) | | | | |
| Substrate thickness | 101.6 | 12.7 | 12.7 | 12.7 |
| (mm) | | | | |
| Substrate Area | 81 | 24.5 | 600 | 600 |
| (cm²) | | | | |
| Substrate Volume | 822.96 | 31.15 | 762 | 762 |
| (cm³) | | | | |
| Density (g/cm³) | 2 | 2 | 7.9 | 1.8 |
| Mass (g) | 1645.9 | 62.23 | 6019.8 | 1371.6 |
| Thermal conductivity | 0.04 | 0.04 | 16 | 85 |
| W/(m · K) | | | | |
| Specific Heat | 45 | 45 | 470 | 720 |
| Capacity (J/kg · K) | | | | |
| Thermal Capacity | 74.0664 | 2.80035 | 2829.306 | 987.552 |
| (J/K) | | | | |
| Ratio Therm. Cap. | 428 | 16 | 16337 | 5702 |
| Precusor/Brick | | | | |
| Piezoelectric | 4.5 | | | |
| coefficient d₃₃ | | | | |
| (pC/N) | | | | |
| Processing | Recessed Brick | Brick | Brick | Brick |
| Method | | | | |
| Substrate Material | Insulating | Silica Based | Rolled Steel | Graphite |
| | Ceramic Brick | Ceramic | (254 × 127 mm) | (254 × 127 mm) |

In Table 2 the ceramization results for textured samples (examples 1 to 4) are summarized.

All the examples given in Table 2 were prepared using the brick method as explained above. All of the Examples showed a marked texture which is indicated in the table on an arbitrary scale (with “4” indicating very pronounced texture and “1” indicating the lowest texture).

All sample sizes were 35 mm diameter, 2 mm thick.

While examples 1 and 2 were placed in a recessed brick of the material according to Table 2 in a flush configuration, examples 3 and 4 were placed on top of the brick.

All specimens were polished on all flat surfaces prior to placing on the brick body. The respective surfaces of the brick bodies in contact with the precursor glass body were ground.

When using a recessed brick, then the recess was made corresponding to the sample size (slightly larger). Thus the respective samples were received flush within the recessed bricks. For facilitating an easy removal of the samples, the recesses were treated with soapstone prior to placing the samples therein.

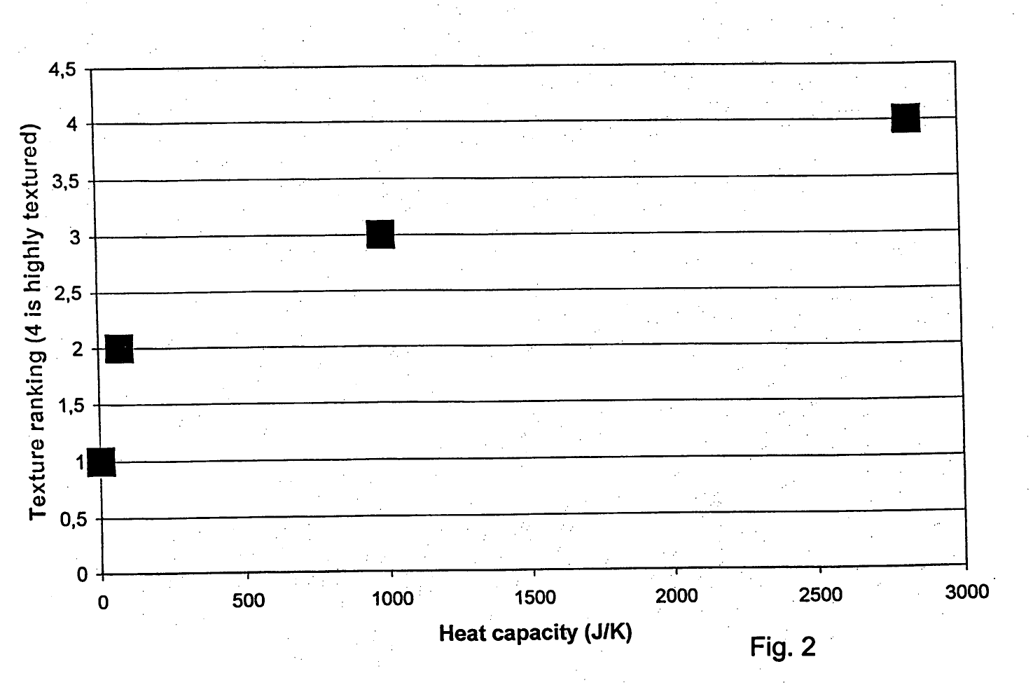

It can be seen from Table 2 that the best texture was reached when using the brick body with the highest thermal capacity. This behavior is demonstrated in FIG. 2.

It is believed that the ratio between the thermal capacities of the brick body and the precursor glass body is the most important parameter influencing the degree of texture. With a calculated thermal capacity of about 0.17 J/K, the ratios between the thermal capacities of the brick bodies and the precursor glass bodies can be calculated as shown in Table 2.

The texture ranking is roughly proportional to the logarithm of the respective ratio.

All examples 1-4 were prepared from the precursor glass shown in Table 1. As determined by X-ray diffraction measurements, from this precursor glass crystallites of Li₂Si₂O₅, Li₂SiO₃ and to some extent quartz precipitated. All these crystallites are polar which allows to generate a piezoelectric behavior.

Piezoelectricity was confirmed by measurement of the piezoelectric coefficient (piezoelectric charge constant) d₃₃ using an APC wide-range d₃₃ meter, model YE2730A. This instrument is based on the Berlincourt method of measuring piezoelectric properties. A reference sample of PZT was used.

A piezoelectric coefficient d₃₃ of 4.5 was confirmed by several measurements for example 1, while not enough measurements were made to provide specific values for the other examples.

What is claimed is:

1. A method of preparing a textured glass ceramic, comprising the steps of:
preparing a precursor glass body;
placing the precursor glass body in a furnace in contact with a brick body having a thermal capacity from a thermal capacity of the precursor glass body; and
ceraming the precursor glass body within the furnace in contact with the brick body.

2. The method of claim 1, wherein a ratio between the thermal capacity of the brick body and the thermal capacity of the precursor glass body is at least 10.

3. The method of claim 1, wherein a ratio between the thermal capacity of the brick body and the thermal capacity of the precursor glass body is at least 10000.

4. The method of claim 1, wherein the brick body is cooled or heated during the ceraming step.

5. The method of claim 1, wherein at least the surface of the precursor glass body in contact in the brick body is polished prior to contacting the brick body.

6. The method of claim 1, further comprising the step of placing the precursor glass body within a recess of the brick body.

7. The method of claim 6, wherein the step of placing the precursor glass body within the recess comprises the step of placing the precursor glass in a flush or recessed configuration within the brick body.

8. The method of claim 1, further comprising the step of grinding or polishing any surface of the brick body getting in contact with the precursor glass body.

9. The method of claim 1, further comprising the step of seeding at least one surface of the precursor glass body by thermal or chemical treatment.

10. The method of claim 1, wherein the precursor glass body is prepared with nucleating agents within the bulk.

11. The method of claim 1, further comprising the step of establishing a gas flow within the furnace, the gas flow being directed to influence the temperature gradient established within the precursor glass body.

12. The method of claim 1, wherein a precursor glass body is chosen which allows to precipitate acentric crystallites therefrom.

13. The method of claim 1, wherein a precursor glass body is used which comprises 55 to 80 wt.-% of SiO₂, 1 to 40 wt.-% of B₂O₃ and 1 to 30 wt.-% of Li₂O.

14. The method of claim 14, wherein a precursor glass body is used which comprises 70 to 73 wt.-% of SiO₂, 9 to 11 wt.-% of B₂O₃, and 18 to 22 wt.-% of Li₂O.

15. A method of preparing a textured glass ceramic, comprising the steps of:
preparing a precursor glass body which comprises 65 to 75 wt.-% of SiO₂, 5 to 15 wt.-% of B₂O₃, and 15 to 22 wt.-% of Li₂O;
placing the precursor glass body in a furnace in contact with a brick body having a thermal capacity from a thermal capacity of the precursor glass body; and
ceraming the precursor glass body within the furnace in contact with the brick body.

16. The method of claim 1, wherein the brick body is made from a thermally insulating material.

17. The method of claim 1, wherein the brick body is made from a material selected from the group formed by graphite, silica, alumina and steel.

18. The method of claim 15, wherein the brick body and the ceraming step are controlled to generate a piezoelectric glass ceramic.

19. A textured glass ceramic body prepared from a precursor glass body by
placing the precursor glass body in a furnace in contact with a brick body having a thermal capacity from a thermal capacity of the precursor glass body; and
ceraming the precursor glass body within the furnace in contact with the brick body.

20. The glass ceramic body of claim 19, comprising non-ferroelectric piezoactive crystallites precipitated from the precursor glass body with a preferred direction of orientation.
